(19) United States
(12) Patent Application Publication
(10) Pub. No.: US 2007/0019194 A1
(43) Pub. Date: Jan. 25, 2007

(54) Full spectral range spectrometer

(76) Inventors: Liangyao Chen, Shanghai (CN); David W. Lynch, Ames, IA (US); David T. Kao, Gainesville, VA (US)

Correspondence Address: David T. Kao, 7941 Amsterdam Ct., Gainesville, VA, 20155, US

(21) Appl. No.: 11/186,004

(22) Filed: Jul. 21, 2005

(51) Int. Cl. G01J 3/28

(52) U.S. Cl. 356/328

(57) ABSTRACT

A spectrometer is designed capable of effectively covering the full desired spectral range using an array of multiple diffraction gratings arranged in gradually differentiated angles to diffract certain sub-range of photon wavelengths to the target detectors without relying on mechanically changing gratings or use of any moving parts. The optically subdivided spectral analysis results are then electronically integrated to accurately yield the desired full range spectral measurement at a speed compatible to the limit of optical and digital analyzers' speed of the measuring system without manual adjustment and/or mechanical movement delays.

### FIELD OF INVENTION

The present invention relates to a monochromator used as an optical spectrum analyzer, which employs several diffraction gratings, along with possible collimating and beam-deflection mirrors, and with a position-sensitive detector to enable coverage of the entire desired spectral range without requiring any motion mechanism to cause continuous or intermittent scanning action.

### BACKGROUND OF THE INVENTION

A spectrometer is a basic instrument used to spectrally disperse light in the infrared (IR—wavelengths longer than 750 nm), visible (wavelength between 400 to 750 nm), and ultraviolet (UV—wavelengths shorter than 400 nm) spectral regions and to record the spectrum, photon flux or radiation intensity, as a function of wavelength to allow for clear identification of the source and characteristics of the incident radiation. The spectrometer has wide and important applications in the optical, electro-optical, magneto-optical, and astrophysical research fields. It is a key optical instrument used in many modem spectral investigations, such as Raman spectroscopy, photoluminescence spectroscopy, optical absorption and emission spectroscopy, optical modulation spectroscopy, and so on. These spectroscopies are utilized in many fields, including analytical chemistry, environmental studies, biochemistry and biomedical chemistry, and optical communications.

The most widely used spectrometer, which works over the spectral range from near-infrared through the visible to the near ultraviolet, is the diffraction-grating spectrometer, ie., a diffraction-grating monochromator with either an exit slit followed by a single-channel detector or with no exit slit, but with a position-sensitive detector in the focal plane. The incident radiation is dispersed into a spectrum by diffraction, interference between electromagnetic waves passing through adjacent slits (transmission grating) or reflecting from adjacent faceted grooves (reflection grating), with different spectral elements (wavelengths) leaving at different angles, and being focused at different positions in the focal plane. Reflection gratings are usually used in monochromators. The may be of three types. Original ruled gratings are made by ruling extremely fine parallel linear grooves on the substrate (called a blank). For example, gratings with 600 grooves/mm, 1200 grooves/mm, or 1800 grooves/mm are commonly available for use under different application conditions. The ruled grating may be over coated with one or more thin fils to protect the surface and, possibly, to enhance the reflectance in a particular spectral region. Preferential spectral enhancement is commonly achieved also by shaping the facets of the grooves (“blazing”). Replica plane gratings are produced by making a casting of a ruled grating. The grooves should match those of the original. Similar over coatings are used. The third type is produced by creating an interference pattern in a thin film of photosensitive material (“photo-resist”) on the blank, using a laser as light source. Subsequent “development” of the photo-resist yields the desired groove pattern, and the surface is then over coated as above. This is called a “holographic grating”.

In the traditional design of the grating monochromator, the locations of both the entrance- and exit-slits are fixed. With a plane diffraction grating, reflecting mirrors, used to collimate the input radiation and to focus the diffracted radiation onto the exit slit, are also fixed. Only a narrow slice of the dispersed spectrum will pass though the exit slit to an external detector, severely limiting the wavelength range of the spectrum that can be observed and analyzed by such a device. To solve this problem, a mechanical system has been used to rotate the grating either manually or by automatic control, i.e. an electric motor, to accomplish the scanning of the desired range of wavelength. For example, if it is desired to analyze a given radiation over a visible and ultraviolet wavelength range of 200-1100 nm, and to also do analysis of near infrared light of 700-1500 nm or 1000-2500 nm wavelength range, the light-dispersing grating of the device needs to be preset to rotate about a range of angles depending on the grating specifications. In this way, the monochromatic photons of the desired wavelength range can be obtained at the exit-slit position and detected for the designed analytical work.

To actually accomplish the task of rotating the light-dispersing element, several different mechanical or electromechanical methods have been currently employed. The well-known ones include the use of a sine bar for linear-to-rotary movement conversion, a step motor with gear reduction mechanisms and open loop control, or a DC servomotor with closed loop control. These mechanical and electromechanical design approaches and other similar ones with specific variations and/or incremental improvements thereof all have some major drawbacks. Complexity of system construction; requirement of periodic adjustment, calibration and maintenance; length of time required to perform each analysis; and potential loss of measurement accuracy are among their principal shortcomings. The latter two are of particular concern when the sine-bar linear-rotary motion conversion or step-motor method is adopted to provide the rotation of the light-dispersing element because of the long times they add to the performance of each analysis.

Another approach to working with a broad spectral range is to use different gratings in the monochromator. This is normally done by selecting gratings blazed with specific groove shapes to enhance the reflectance of a given narrow spectral region to obtain data with the best signal-to-noise ratio, but, at the expense of lowered reflectance for radiation wavelengths outside this region. Therefore, in order to cover the entire desired range of the spectrum, the grating needs to be changed according to each sub-section of the wavelength range to be observed. For example, to perform an analysis over the 200-1100 nm wavelength range, at least 2, or possibly 3 or 4 different gratings need to be used in order to satisfy the measurement precision requirement over the entire spectral range.

The aforementioned tasks of changing gratings and the filters, needed to block higher-order diffracted radiation, can be accomplished manually or using a motor-driven system during the scanning action. In most commercial monochromators, these functions are commonly carried out using two independent mechanically controlled systems. This not only makes the optical design of the instrument more complicated, but also reduces its reliability. Furthermore, it causes inconvenience and increases the length of time required in each application. The latter is especially costly because when the grating is changed it may be accompanied by the need for optical system adjustment and re-calibration.

To increase the efficiency and precision of the spectral scanning, a one- or two-dimensional array of UV-enhanced charge-coupled device (CCD) detectors is widely used inside the grating monochromator to record rapidly the diffracted radiation over a broad spectral range. With such a detector inside the monochromator, the device is now a spectrometer. However, according to current practice among the existing devices, the grating must still be rotated in steps using a controlled mechanically system to cover the entire spectral region detectable by the CCD with a working wavelength range of 200-1100 nm This is particularly so if high resolution is desired, for then one may have to image just one “resolution element” of the spectrum,Δλ wide, on one pixel width of the detector. This requires high linear dispersion on the focal plane, which spreads the spectrum out, making it wider than the width of the CCD detector, and necessitating scanning the grating angles or replacing the grating in order to record the complete desired spectrum This, in fact, greatly reduces the speed advantages and value of using the CCD detectors.

Besides, in a rotating-grating type monochromator, additional mechanical, optical or electric switches and position-detection sensors are normally needed. The former are used to prevent the grating from accidentally over-rotating, causing damage to the system The latter is needed to accurately mark the grating's angular position in relation to the incident spectral signals to be analyzed and is particularly important in the case, mentioned previously, of using a DC servomotor that is normally designed to rotate fast and with 360-degree full motion. These further complicate the design and construction of the instrument.

It is therefore a principal objective of this invention to provide a monochromator capable of covering the full desired spectral range without requiring changing or moving parts.

A further objective of this invention is to provide a spectrum analyzer wherein the vertical column of the collimated incident radiation is divided into sub-sections.

A still further objective of this invention is to provide an improved monochromator using multiple gratings of the same groove density and/or different groove densities and blaze angles, enabling one to obtain enhanced reflectance in specified spectral regions as desired.

A still further objective of this invention is to provide a monochromator wherein the multiple gratings are fixed in gradually differentiated angles to receive the collimated incident radiation of certain sub-range of photon wavelengths and diffracting them in the a preset direction.

A still further objective of this invention is to provide a monochromator wherein the diffracted radiation in all different wavelength sub-sections from the multiple gratings is directed toward the same focusing mirror that, in turn, reflects the focused photon beams toward a corresponding array of CCD detectors.

A still further objective of this invention is to provide an improved spectrum analyzer wherein the incident spectrum is subdivided along the horizontal wavelength distribution line (dispersion direction) into preset sub-sections, each being digitally marked to allow seamless reconnection into the fill spectral map.

A still further objective of this invention is to provide an improved spectrum analyzer wherein the optically subdivided spectral analysis results are electronically integrated to accurately yield the desired full-range spectrum at a speed compatible to the limit of optical-digital speed of the measuring system, without mechanical movement and/or re-adjustment and re-calibration delays.

A still further objective of this invention is to provide a software package to control the instrument, to process the results and to achieve coverage of the entire desired spectral range.

A still further objective of this invention is to provide an optical spectrum analyzer wherein an adjustable entrance slit is employed allowing selective control of the incident radiation to achieve the optimum measuring results.

This device is specifically an improvement over the device of patent granted in China with Chinese Patent No. 02137501.1

These and other objectives will be apparent to those skilled in the art.

### SUMMARY OF THE INVENTION

In the case of a plane grating used in a monochromator, the optically collimated photons of a given wavelength falling on the grooved grating surface are reflected, due to the diffraction effect, into discrete directions for a fixed angle according to the following rule,
: mλ=d(sin α+sin β), (1)
where λ is the wavelength of the diffracted radiation, and m is an integer (positive or negative) representing the order of diffraction; d is the spacing between adjacent grooves on the grating surface; α and β are the angles of the incidence of the collimated light on the grating and of the diffracted beam respectively, measured from the line normal to the grating plane. Therefore, for m =1, the first-order diffracted photons with wavelength λ₍ₘ₌₁₎ can be obtained at the corresponding β₍ₘ₌₁₎ position. To make a monochromator with a signal detector of sufficient width that it is capable of covering the broad range of, β angles to record the full desired range of spectral analysis effectively and efficiently, has been proven difficult, often resulting, in the existing practice, to the use of manually or mechanically rotating the grating or changing gratings.

In the present invention, we made significant improvements on the design of a monochromator. An array of several gratings combined with an advanced CCD detector array is used, arranged in a manner to enable coverage of the entire desired wavelength analysis without requiring any mechanical moving parts. For example, if the desired wavelength coverage is the entire 200-1100 nm range, depending on the accuracy requirements, we can use an array of three or more gratings with each being set at a predetermined angle to simultaneously cover a sub-section of the full wavelength range of the spectrum As a result, the full desired spectral range can be realized in one instant (one CCD integration time) in the present invention. Furthermore, the design and construction of the new monochromator system, without any moving parts and related controlling devices, is much simpler. In addition, the new design makes the system more reliable and much faster in obtaining the desired spectra, with longer instrument life with minimum required maintenance and service needs.

Theory and Operation of the Invention

According to Equation 1, when the optically collimated photons of a given wavelength λ strike a plane grating of specific line density, the spacing, d, between adjacent grooves on the grating surface is a constant. Furthermore, by mounting the grating in a fixed position, the angle of incidence α of the incoming photons is defined; thus the value of sina is also fixed. The optically collimated beam can be diffracted by the grating into numerous beams, all with wave-length λ at various angles β₍ₘ₌₁₎=β₁, β₍ₘ₌₂₎=β₂,β₍ₘ₌₃₎=β₃, and so on, representing primary (first order, m=1) and higher-order diffraction beams with order number m =2, 3. . . . n. (n is limited by the condition that sin β≦1.) This becomes more obvious by rearranging Equation (1) into the following form:

$$sin β = \frac{m λ}{d} - sin α . \qquad ( 2 )$$

Furthermore, according to Equation (2), for a given pair of m and λ, diffracted radiation with several different discrete wavelengths could emerge from the exit slit or appear at the same point on the focal plane of a spectrometer. This means that while the wavelength, λ₍ₘ₌₁₎ satisfies Equation (2) with m=1, wavelengths λ₍ₘ₌₂₎=λ₍ₘ₌₁₎2, λ₍ₘ₌₃₎=λ₍ₘ₌₁₎/3 etc. will satisfy the same equation for m=2, m=3, and so on. If any of these shorter wavelengths is present in the incident radiation, such “higher-order” radiation must be removed by a filter, even though the blaze of the grating will reduce its relative intensity. Therefore, according to the application condition, one or more optical filters may be needed to cut off the higher-order photons.

The aforementioned considerations point to the fact that, in the case of using a single plane grating at a fixed angle of incidence α of the incident collimated photons, the corresponding angles of the first-order diffracted beam β₁ will have a range of different values covering a broad wavelength range. This means that, in order to image the entire desired range of wavelength, for example, to cover the 200-1100 nm range, one will need a position-sensitive detector that is physically wide enough to cover the broadly spread diffracted, focused monochromatic radiation beams. Otherwise, some of the diffracted radiation will fall outside the detector. To use a detector of such a large size, in most cases, is impractical.

To overcome this problem, conventional methods adopted the approach of manually or electro-mechanically rotating the grating to cause the incidence anglea and the diffracted angles β to change, or to manually or electro-mechanically change grating using several of different line densities, thereby changing the spacing d between adjacent grooves in Equation (2). Both approaches are aimed at varying the diffracted radiation beam angles β to cause the desired spectral segment to fall inside the limited width of the detector. These approaches have certain shortcomings, including: time delay; loss of accuracy; complexity of design and manufacturing; and frequent calibration and maintenance requirements.

The present invention adopts an entirely different approach. The principal elements involved in this innovation include: (1) to send the incident radiation spectrum to several fixed gratings of the same or different groove spacing, one above another; (2) to image the spectrum from each grating simultaneously on a separate horizontal section of a position-sensitive detector, e.g., a charge-coupled detector (CCD; and (3) to seamlessly splice together the spectrum from each horizontal section of the detector into the full desired spectrum using digital means. The new device employs no moving parts and requires no in-situ adjustment of grating angles or interchanging of gratings, and thus eliminates the said shortcomings accompanying the conventional designs.

In actual design, depending on operational requirements, it is possible to offset the angle of the plane grating to vary the angle of incidence α in Equation (2) or use different grating ruling densities, or use a combination of both. When the latter is adopted, broad wavelength coverage with high precision spectral analysis can be achieved without resulting in either increasing system complexity or lengthening spectral acquisition time.

The detector is an array of photosensitive elements (“pixels”), usually N×N. In ideal use, a small section of the spectrum Δλ lands on a vertical stripe of the detector, one pixel wide and N pixels high. For highest resolution, radiation in the range Δλ determined by the entrance slit width, the grating width, and the quality and alignment of the grating and mirrors will just fill one-pixel width. The signal from Δλ will be proportional to N. For a given incident photon flux, the signal-to-noise ratio from an ideal detector will be proportional to √N. In the present invention, the spectrum from one of the g gratings, will occupy N/g pixels in a vertical stripe. The ideal signal-to-noise ratio becomes √N/√g, smaller by a factor of 1/√g. g typically will be 2-5. The loss in signal to noise will not be excessive.

### BRIEF DESCRIPTION OF THE DRAWINGS

FIG. 1 is a perspective view of the monochromator of this invention;

FIG. 2 shows the principle of beam slicing and the use of offset grating plane angles to bring spectral subsections into alignment into target position; and

FIG. 3 illustrates the result of digitally spliced subsections to accomplish full spectral analysis objectives.

### DESCRIPTION OF THE PREFERRED EMBODIMENT

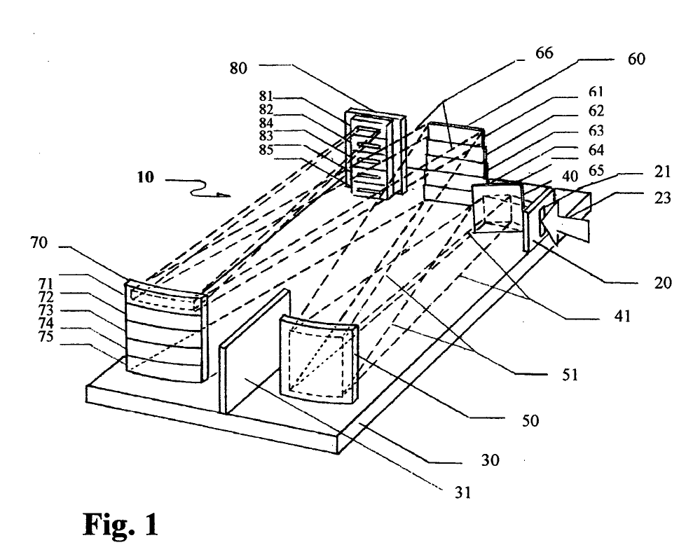

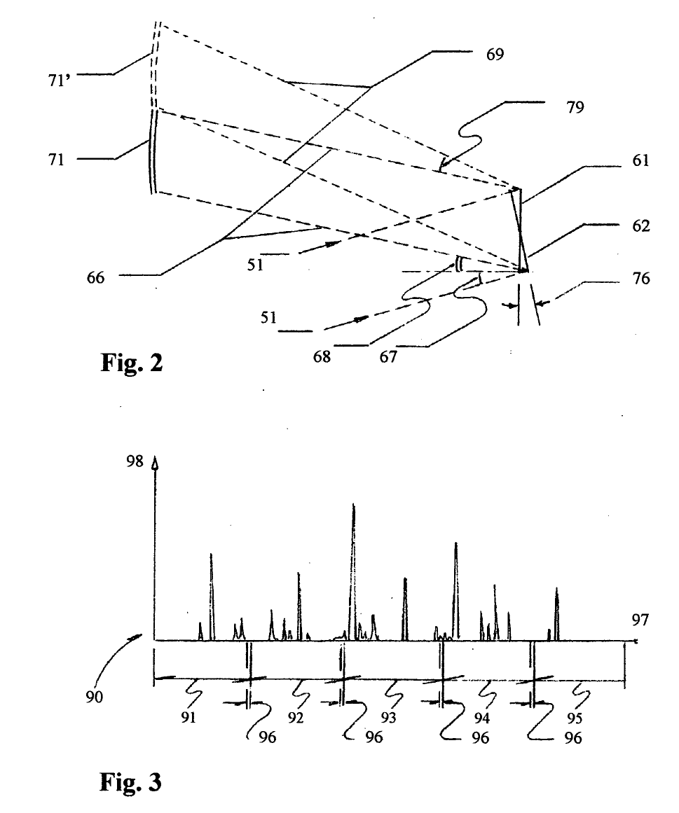

FIGS. 1 through 3 show the principal elements of this invention. Numeral 10 in FIG. 1 designates the monochromator designed to embody the fundamental theory and operational principles employed in this invention FIG. 2 illustrates the concept of selecting the preset angle of the grating plane to bring the offset of the full spectrum from the sub-set diffracted spectra

With reference to FIG. 1, a plate 20 with an adjustable width vertical slit 21 is mounted on the base plate 30 to allow incident optical radiation 23 to enter the monochromator and to properly position it on the reflection mirror 40. The reflected radiation 41 is directed onto a concave mirror 50 to produce optically collimated plane waves 51. A partition plate 31 is properly placed adjacent to the concave mirror 50.

As illustrated herein FIG. 1, when the collimated waves reach the array of gratings 60, they are horizontally sliced into a number of spectral subsections. The number of subsections can be pre-determined in accordance with the users' needs on the bases of characteristics of the incident radiation to be analyzed and the detail and precision requirements of the spectral analysis.

In this preferred embodiment of the present invention we choose to use five horizontally mounted grating strips 61, 62, 63, 64, and 65. The gratings of different densities are also selected to illustrate the combination of their use together with the spectrum-slicing innovation to yield optimum spectral analysis. For example, to cover wavelengths in the 200-1100 nm range in the present invention, the basic gratings selected could include one with 1200 grooves/mm, blazed at about 250 nm (numeral 61); two with 1200 grooves/mm, blazed at about 450 nm (62, and 63); and two with 600 grooves/mn, blazed at about 750 nm (64 and 65).

The grating plates 62, 63, 64, and 65 are mounted respectively at predetermined offset angles Δθ₂, Δθ₃, Δθ₄ and Δθ₅ measured relative to the primary grating-receiver alignment position, and designated, e.g., by numeral 76 (for Δθ₂) shown in FIG. 2. Further depicted in FIG. 2 is the operational principle on how a small horizontal angular offset mounting of the grating plate helps to bring the subsection of the spectrum falling outside of the principal signal receiving position back to within the detector boundaries.

With reference to FIG. 2, let the grating 61, diffracted radiation wave 66, and focusing mirror 71 be at their designated principal alignment positions. With the incoming collimated waves 51 striking the grating at an angle of incidence α (67), the first-order (m=1) diffracted beams reflect from the grating plate at angles β₍ₘ₌₁₎=β₁ (68). If the incident radiation has a broad spectrum, extending between λ₁ and λₛ, the angular spread in values of β₁ may be so large that much of spectrum misses the detector when mirror 71 focuses the diffracted beam on the upper part (81) of the position-sensitive detector (80). Grating (61) is aligned so that, e.g., the longest-wavelength segment of the spectrum, λ₁ to λₐ falls on the upper detector segment 81.

The next grating down (62), which may or ray not have the same ruling density as grating 61, is mounted at a small horizontal angle Δθ₂ offset from that of grating 61 so that the next shorter-wavelength segment of the spectrum, starting at λₐ (or possibly a little longer wavelength to produce some spectral overlap) and ending at λ_{b}, is imaged on the next-lower segment of the detector (82).

For grating 62 to remain in the same vertical plane of 61, the segments of the spectrum (69) for λ greater than λₐ and smaller than λ_{b} will fall outside the range of focusing mirror 71 and onto an adjacent area marked 71′ in FIG. 2 and, consequently, miss the signal receiving detector. By mounting the grating plate 62 at a small horizontal offset angle Δθ₂ (76), the diffraction radiation wave of next shorter wavelength will correspondingly be pulled back by an angle 79 to fall onto the focusing mirror 72 (FIG. 1) placed below and vertically in line with 71. These segments of the spectrum, thus, are brought back to detector 82 (FIG. 1). By applying this new design procedure to gratings 63, 64, and 65, the segments of the spectrum for λ between λ_{b} to λₛ will all be brought back in alignment with the reflecting mirrors 73, 74 and 75 and the detector array 83, 84 and 85. Consequently, the former segment (λ greater than λₐ) is detected by detector section (81) and the latter (λ smaller than λ_{b}) will be detected by detector parts 83-85 after having been diffracted by gratings 63-65.

FIG. 1 shows five gratings and detector sections. A lesser number, two, three, or four, will suffice in some applications. Each of the gratings, 61-65, may also send higher-order (m>1) diffracted radiation to the detector, if such wavelengths are present in the input radiation. This must be filtered out, if the detector has a response at these wavelengths. This can be done by filters placed between the gratings and the detectors, possibly one for each of the longer-wavelength segments of the spectrum. In some cases, a filter in the input beam would suffice.

The signals received from the CCD array 81-85 are spectral subsections corresponding to those initially sliced by the array of gratings 61-65. The CCD outputs will be transmitted to a digital computer directly for data reduction and analysis. These spectral subsections 91, 92, 93, 94 and 95 could be illustrated as shown in FIG. 3. FIG. 3 is plotted on a two-axis system (90), where the horizontal axis 97 represents the wavelength k and the vertical axis 98 gives intensity of various waves in the detected spectrum Also illustrated in FIG. 3 are small wavelength segments 96 overlapping the output spectrum, which, if needed, could be included for the purpose of enhancing splicing accuracy. An accompanying computer software package has been developed to accurately splice the subsections together to yield the full desired spectrum analysis results.

A standard spectral lamp can be used to calibrate the system easily.

What is claimed is:

1. A full spectral range spectrometer comprising:
a light beam input and dispersing element;
a concave reflecting mirror to optically collimate the radiation waves;
an array of diffraction gratings and means to optically slice the incoming spectrum into a number of spectral sub-sections;
a concave reflecting mirror to focus the diffracted beam on the detectors;
an array of detectors receiving each spectral sub-sections; and
means to transmit, process and reconstruct a spectrum map covering the full range of wavelengths electronically at a high speed compatible to the speed of the electro-optical processing system itself.

2. A spectrometer as defined in claim 1 consists of a device that effectively covers a full desired range of photon wavelength and a method that efficiently accomplishes the required spectral analysis.

3. The device of claim 1 covers the full desired spectral range by using an array of diffraction gratings which are of the same or different selected groove densities, arranged in gradually differentiated angles, and designated according to needs of the spectral analysis to each cover a certain sub-range of photon wavelengths without relying on any mechanical moving parts.

4. Method and analysis related to determining the gradually differentiated offset grating-plane mounting angles for the device of claim 3 are developed.

5. The optical means of slicing the incoming spectrum as defined in claim 1 wherein each of the said spectral sub-sections retains the full original spectrum of photon energy of different wavelengths with only the designated sub-range wavelength section being diffracted toward the detector array.

6. The diffracted photon beams of different wavelengths of claim 4 are directed toward the concave focusing mirror that in turn reflects the photon beams and focuses them on one or more suitable-type position-sensitive detectors.

7. The optically subdivided spectral analysis results of claim 5 are electronically integrated to accurately yield the desired full-range spectral measurement at a speed compatible to the limit of optical and digital analyzers' speed of the measuring system without requiring manual adjustment and/or mechanical movement delays.

8. The device of claim 1 wherein has an adjustable entrance slit allowing selective control of the incident radiation to achieve the optimum spectral resolution and measuring results.
